(19) United States
(12) Patent Application Publication
(10) Pub. No.: US 2012/0259878 A1
(43) Pub. Date: Oct. 11, 2012

(54) STRUCTURED TEXT SEARCH-EXPRESSION-GENERATING DEVICE, METHOD AND PROCESS THEREFOR, STRUCTURED TEXT SEARCH DEVICE, AND METHOD AND PROCESS THEREFOR

(75) Inventors: Keiichi Iguchi, Tokyo (JP); Kazuya Koyama, Tokyo (JP)

(73) Assignee: NEC Corporation, Minato-ku, Tokyo (JP)

(21) Appl. No.: 13/392,448

(22) PCT Filed: Aug. 20, 2010
(86) PCT No.: PCT/JP10/64068

§ 371 Date: Jun. 28, 2012

(30) Foreign Application Priority Data
Aug. 26, 2009 (JP) 2009-195449

(51) Int. Cl. G06F 17/30

(52) U.S. Cl. 707/758; 707/E17.008

(57) ABSTRACT

Provided is a structured document search formula generating device capable of generating a search formula, which searches for a target element by automatically specifying an element acting as a guideline as a search condition when the element acting as the guideline is not structurally present on a structural related position but the element acting as the guideline is present on a display screen. The structured document search formula generating device is provided with a sample text accumulating unit, which accumulates a plurality of sample texts each composed of a structured document being a search target for each document type, an element specifying unit, which specifies a search target element in each of a plurality of sample texts, a structure analyzing unit, which analyzes a structure of a specified sample text and generates a search formula indicating a structural position of the specified search target element in a structure of the sample text, a screen analyzing unit, which analyzes a display image of the specified sample text and determines the element present on a common relative position on the display image of each of a plurality of sample texts as a guideline element on a screen, and a search formula combining unit, which generates one obtained by adding the determined guideline element on the screen as a condition to the search formula indicating the generated structural position.

### TECHNICAL FIELD

The present invention relates to a structured text (or document) search expression (or formula) generating device, a method and a program thereof, and a structured document search device, a method and a program thereof, and especially relates to a structured document search formula generation system capable of automatically generating a search formula in which a denotative positional relationship is described in a condition.

### BACKGROUND ART

The patent literature 1 discloses an example of a data extraction system, which extracts desired information from a Web page, of which search target is a structured document such as a Hyper Text Markup Language (HTML) document.

The data extraction system of the patent literature 1 has a communication device, a central processing unit, data extraction means (data extraction program), and data extraction reconstruction means (data extraction reconstruction program). The data extraction means extracts a predetermined character string as extraction basic data in advance from the Web page and stores the same. When the Web page is changed, the data extraction reconstruction means searches for the extraction basic data from the changed Web page and, based on information indicating a position of an HTML structure of the searched extraction basic data, reconstructs the data extraction means, which extracts the character string corresponding to an extraction basic data position in the HTML structure of the Web page before being changed from the Web page having the same HTML structure as that of the changed Web page with different contents.

Specifically, in the above-described configuration, the data extraction reconstruction means obtains the Web page using the communication device, compares the same with the previously obtained Web page, and judges whether the HTML structure is changed. When there is the change, this obtains the Web page with a new HTML structure by referring to a uniform resource locator (URL) described together with a value (character string) of the extraction basic data. Next, the data extraction reconstruction means searches for the value of the extraction basic data from the Web page with the new HTML structure and reconstructs the data extraction program using tags before and after the same. According to this, it is possible to generate an adapted data extraction program even when the HTML structure changes.

On the other hand, the patent literature 2 discloses an image communication system capable of reducing a communication amount and a communication time without transmitting/receiving image data for an overlapping portion of each graphic object described in multimedia descriptive data. The image communication system of the patent literature 2 discloses a technique to specify an element to be extracted by an identifier of an image and regional information of the image.

Also, the non-patent literature 1 discloses a technique to extract a specific element by allowing the structured document to include the identifier.

### CITATION LIST

### Patent Literature

{PTL 1} JP-A-2005-301437
{PTL 2} JP-A-2003-303091

### Non-Patent Literature

{Non-PTL 1} Microsoft Corporation, “Subscribing to Content with Web Slices”, MSDN Library, [online], {Searched on Jul. 13, 2009} Internet <URL: http://msdn.microsoft.com/en-us/library/cc196992(VS.85).aspx>

### SUMMARY OF INVENTION

### Technical Problem

A problem of the above-described techniques is that, the search formula described as a condition cannot be automatically generated when an element acting as a guideline (guideline element) of a search target element is present on a display screen of the Web page but the element acting as the guideline is not present on a structural related position. This is because the conventional structured document search formula describes only a structural positional relationship as the condition, this cannot automatically find the element acting as the guideline on the display screen, and this cannot describe the same as the condition.

That is to say, in the structured document in which the guideline on the screen is arranged by adjusting a position on the display screen, a relationship between the guideline element and the search target element is not structurally represented, so that this cannot determine the element acting as the guideline. As a result, information, which may be commonly specified in a plurality of sample texts, is limited only with the structural positional information, and there is a case in which the element cannot be uniquely specified.

Also, since the information is extracted by the regional information in the element extracting technique in the patent literature 2, it is not possible to describe the search formula to extract a target element in the structured document in which a display region changes by an information amount and contents described.

Also, in the element extracting technique in the non-patent literature 1, it is required that the identifier is included in a site, which should be extracted, of the structured document, so that it is not possible to describe the search formula to extract the target element from the structured document in which the identifier is not included in the site, which should be extracted.

An object of the present invention is to solve the above-described problem and provide the structured document search formula generating device capable of generating the search formula to search for the target element by automatically specifying the element acting as the guideline as the search condition when the element acting as the guideline is not present on the structural related position but the element acting as the guideline is present on the display screen.

### Solution to Problem

In order to achieve the above object, a structured document search formula generating device according to the present invention includes: a sample text accumulating unit, which accumulates a plurality of sample texts each composed of a structured document being a search target for each document type; an element specifying unit, which specifies a search target element in each of the plurality of sample texts; a structure analyzing unit, which analyzes a structure of the sample text specified by the element specifying unit and executes a process to generate a search formula indicating a structural position of the specified search target element in a structure of the sample text; a screen analyzing unit, which analyzes a display image of the sample text specified by the element specifying unit and executes a process to determine an element present on a common relative position on the display image of each of the plurality of sample texts as a guideline element on a screen; and a search formula combining unit, which executes a process to generate one obtained by adding the guideline element on the screen determined by the screen analyzing unit as a condition to the search formula indicating the structural position generated by the structure analyzing unit.

### Advantageous Effects of Invention

An effect of the present invention is that it is possible to provide the structured document search formula generating device capable of automatically selecting the element, which should be the guideline, and describing the same in the search formula when the element acting as the guideline is not present on the structural related position but the element acting as the guideline is present on the display screen. This is because the element present on the common relative position to the target element on the screen is added to the condition as the guideline element by analyzing the display image for a plurality of sample texts.

### BRIEF DESCRIPTION OF DRAWINGS

FIG. 1 A block diagram illustrates a configuration of a structured document search formula generation system according to a first embodiment of the present invention.

FIG. 2 A flow diagram illustrates entire operation of the structured document search formula generation system illustrated in FIG. 1.

FIG. 3 A flow diagram illustrates detailed operation of screen analysis (step S205) illustrated in FIG. 2.

FIG. 4 A view illustrates a specific example of a first sample text in the operation in FIGS. 2 and 3.

FIG. 5 A view illustrates a specific example of a second sample text in the operation in FIGS. 2 and 3.

FIG. 6 A view illustrates a specific example of a display image of the first sample text in the operation in FIGS. 2 and 3.

FIG. 7 A view illustrates a specific example of a condition indicating a candidate of a guideline element in the first sample text in the operation in FIGS. 2 and 3.

FIG. 8 A view illustrates a specific example of structural positional information in the first sample text in the operation in FIGS. 2 and 3.

FIG. 9 A view illustrates a specific example of the display image of the second sample text in the operation in FIGS. 2 and 3.

FIG. 10 A view illustrates a specific example of the condition indicating the candidate of the guideline element in the second sample text in the operation in FIGS. 2 and 3.

FIG. 11 A view illustrates a specific example of the structural positional information in the second sample text in the operation in FIGS. 2 and 3.

FIG. 12 A view illustrates a specific example of a search formula obtained by the first sample text illustrated in FIG. 4 and the second sample text illustrated in FIG. 5.

FIG. 13 A block diagram illustrates the configuration of the structured document search formula generation system according to a second embodiment of the present invention.

FIG. 14 A block diagram illustrates a configuration of a structured document search system according to a third embodiment of the present invention.

### DESCRIPTION OF EMBODIMENTS

Next, embodiments of the present invention are described in detail with reference to the drawings.

### First Embodiment

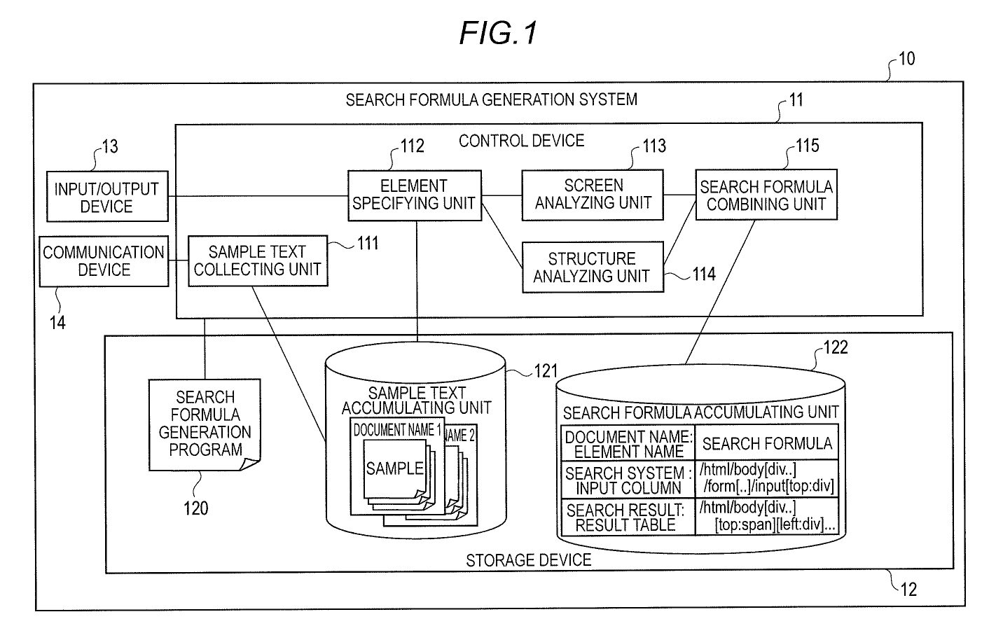

With reference to FIG. 1, a structured document search formula generation system (structured document search formula generating device) 10 being a first embodiment of the present invention is composed of a control device 11, which operates by program control, a storage device 12, a display device 13, and a communication device 14.

The control device 11 sequentially reads to execute a search formula generation program 120 stored in the storage device 12, thereby analyzing a structure of a sample text and adding a condition common in a plurality of sample texts of a same type, and also, the control device 11 executes a function to delete a different element in a plurality of sample texts of the same type from a search formula. Therefore, the control device 11 includes a sample text collecting unit 111, an element specifying unit 112, a screen analyzing unit 113, a structure analyzing unit 114, and a search formula combining unit 115 as means corresponding to each function when functional deployment of a structure of the search formula generation program 120 executed by the control device 11 is performed. These means operate substantially as follows.

The sample text collecting unit 111 obtains the structured document, which is a search target, and accumulates them in the sample text accumulating unit 121 created in the storage device with a document name assigned for each document type. The sample text collecting unit 111 may obtain the structured document from an externally connected server (not illustrated) through the communicating unit 14. Meanwhile, a preferred example of the structured document, which is the search target, is an HTML document.

Herein, the “document type” is of the documents output by a same system for a same purpose, and is classification such as a condition input page, a result list page, and a detailed display page, for example. A preferred example of the document name is a title of the document described in the structured document and a URL for obtaining the structured document. Also, it may be configured such that a user is allowed to input the document name by operating an input/output device 13. Meanwhile, as will be described later, the structured documents are accumulated for each document name in the sample text accumulating unit 121 of the storage device 12.

The element specifying unit 112 has a function to specify the search target in each of the sample texts accumulated in the sample text accumulating unit 121 of the storage device 12 and deliver the sample text obtained from the sample text accumulating unit 121, an identifier for identifying a search target element in the sample text, and the search target to the screen analyzing unit 113 and the structure analyzing unit 114.

The screen analyzing unit 113 has a function to obtain the structured document from the sample text accumulating unit 121 by the sample text delivered from the element specifying unit 112, create a display image, and determine an element present on a relative position common in a plurality of sample texts to the search target element specified by the element specifying unit 112 as a guideline element, which should be added to the search formula. A preferred example of a method of displaying the display image is that the structured document is the HTML document and the screen analyzing unit 113 is provided with a HTML rendering engine to create a HTML display image.

The structure analyzing unit 114 has a function to obtain the structured document from the sample text accumulating unit 121 by the sample text delivered from the element specifying unit 112, analyze the same, and compose the search formula indicating a structural position of the element specified by the element specifying unit 112. The structure analyzing unit 114 further has a function to compose the search formula indicating a common structural position for the specified elements in a plurality of sample texts. A preferred example of the search formula is an XPath formula. The Xpath is a Path indicating a position of an object defined by specifications of Extensible Markup Language (XM) being a structured language. For example, in a plurality of sample texts, if there is only information indicating that the common structure of the specified elements is an HTML DIV tag, it is described “//div” by the XPath formula.

The search formula combining unit 115 has a function to add as a condition indicating the relative position of the target element on which the guideline element received from the screen analyzing unit 113 should be present to the search formula indicating the structural position received from the structure analyzing unit 114 and accumulate the same in the search formula accumulating unit 122 of the storage device 12. A preferred example to describe the condition is to represent by combining a sign (top, bottom, right, and left) indicating top, bottom, right, and left on a screen on which the guideline is present and the XPath indicating the guideline element as a predicate of extended description of the XPath as illustrated in a search formula 1000 in FIG. 10.

Meanwhile, the element specifying unit 112 may be configured to display the structured document on the screen by the input/output device 13 and allow the user to indicate the element, which is a detection target. Also, this may be configured to input the search target element for each structured document as a list.

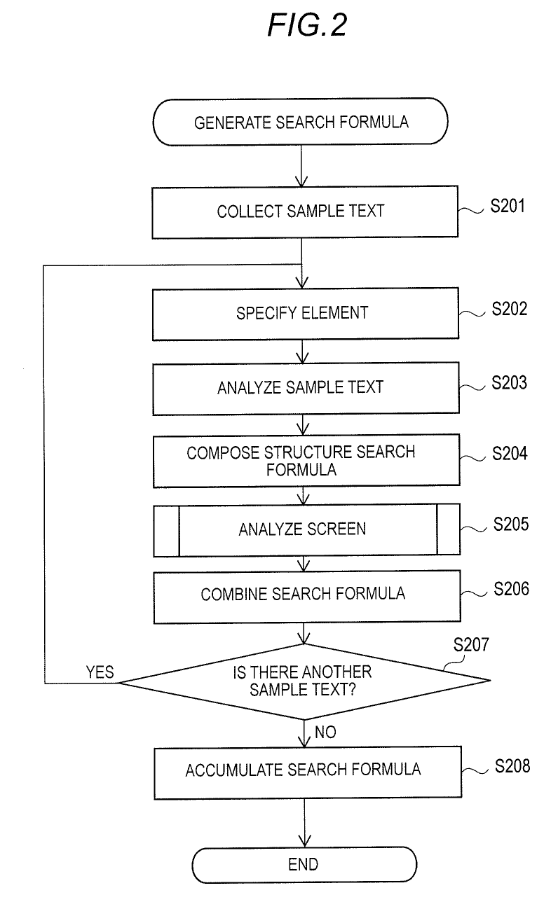

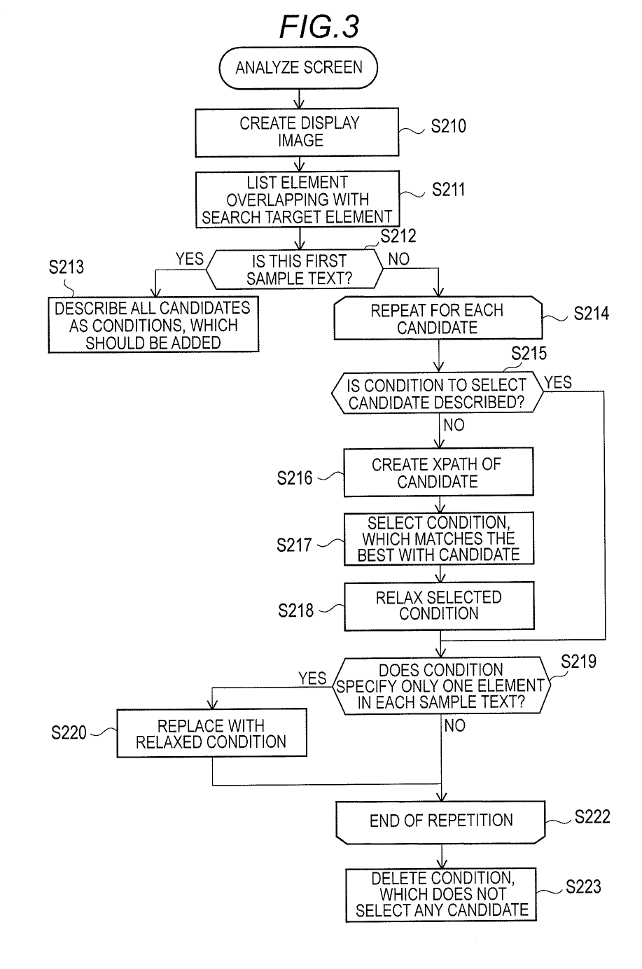

Next, entire operation of this embodiment is described in detail with reference to a configuration diagram in FIG. 1 and flowcharts in FIGS. 2 and 3.

First, the sample text collecting unit 111 collects a plurality of structured documents, which are the search targets, and accumulates them in the sample text accumulating unit 21 of the storage device 12 with the document name assigned for each document type (step S201).

Next, the element specifying unit 112 displays one structured document out of the sample texts of the same document type on the screen of the input/output device 13, captures the element, which is the detection target, from the structured document, and delivers the same to the structure analyzing unit 114 and the screen analyzing unit 113 (step S202).

Upon receiving this, the structure analyzing unit 114 analyzes the structure of the sample text (step S203) and composes the search formula indicating the structural position of the search target (step S204).

Also, upon receiving the sample text and the search target element delivered from the element specifying unit 112, the screen analyzing unit 113 determines the element, which should be added to the search formula as the condition, out of the elements present on the relative positions on the screen to the search target element (step S205). A detailed procedure for determining the element, which should be added, will be described later.

Subsequently, the search formula combining unit 115 receives results of the screen analyzing unit 113 and the structure analyzing unit 114 and adds on-screen position information to a structural search formula (step S206).

The above-described processes from the step S202 to the step S206 are repeated the number of times of required sample texts of the same document type (step S207).

When the processes are completed for all the sample texts, the search formula combining unit 115 accumulates a combined search formula in the search formula accumulating unit 122 (step S208).

Next, with reference to FIG. 3, detailed operation for determining the element, which should be added to the search formula as the condition, by the above-described screen analysis (step S205) is described.

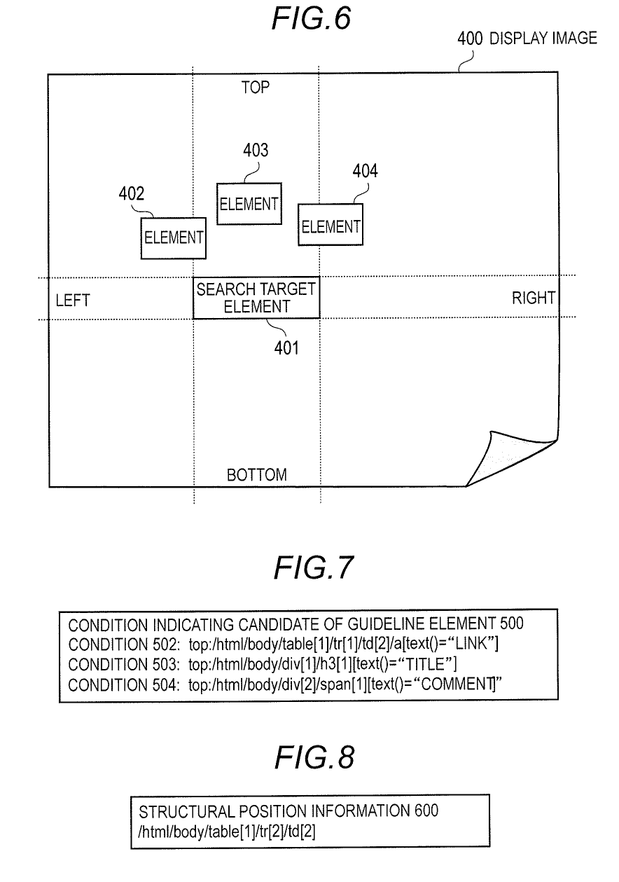

The screen analyzing unit 113 first analyzes the sample text delivered from the element specifying unit 112 and creates the display image (refer to FIG. 6 to be described later) (step S210).

Next, this lists the elements overlapping with the search target element as candidates of the guideline element (step S211). Herein, to be present on the overlapping position is intended to mean that a coordinate on an abscissa axis is present between a right end and a left end of the search target element or that the coordinate on a longitudinal axis is present between an upper end and a lower end of the search target element.

Next, it is confirmed whether the sample text being processed is a first sample text (step S212). As a result, when this is the first sample text (step S212: YES), the XPath formulae of all the listed candidates are described as the conditions (step S213). On the other hand, when this is not the first sample text (step S212: NO), following operation is repeated for each candidate (step S214).

First, when the condition that the candidate becomes a search result is already registered, the procedure shifts to a step S219. When the condition to select the candidate is not registered, the XPath formula of the candidate is created (step S216).

Next, the condition, which matches the best with the created XPath formula, is selected (step S217). The condition, which matches the best, is that with the largest number of matching steps when the condition and the created XPath formula are decomposed to each step, for example. Also, in another example, this is the condition to select the element having a same character string value.

Next, by relaxing a part of the selected condition, it is changed such that the candidate is selected (step S218). For example, it is relaxed by making the step, which does not match with that of the candidate, out of the steps of the XPath formula of the condition, an optional element. Also, in another example, it is relaxed by making an order of appearance optional for the step in which the order of appearance of the elements does not match with that of the candidate out of the steps of the XPath formula of the condition.

Next, it is confirmed whether the condition specifies only one element for each processed sample text by the condition (step S219). As a result, when only one element is specified for all the sample texts (step S219: YES), it is replaced with a new condition (step S220).

The above-described processes from the step S214 to the step S220 are repeated for each candidate (step S222). After all the candidates are processed, the condition, which is not used for selecting any candidate, is deleted (step S223).

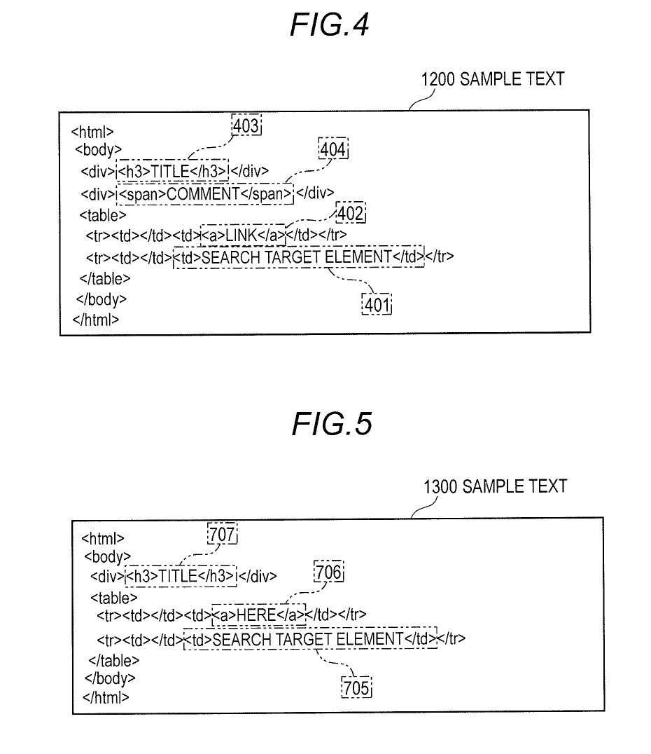

Next, a specific example of the operation illustrated in FIGS. 2 and 3 (steps S201 to S208 and S210 to S223) is described with reference to FIGS. 4 to 12.

The sample text collecting unit 111 collects a sample text 1200 illustrated in FIG. 4 and a sample text 1300 illustrated in FIG. 5 and accumulates them in the sample text accumulating unit 121.

Next, the element specifying unit 112 displays the sample text 1200 as the first sample text as illustrated in FIG. 6, specifies a search target element 401 by an instruction by the user, and delivers the same to the screen analyzing unit 113 and the structure analyzing unit 114.

The structure analyzing unit 114 generates structural position information 600 of the search target element 401 by the XPath formula as illustrated in FIG. 8 as a preferred example of indicating the structural position.

The screen analyzing unit 113 generates a display image 400 of the sample text 1200 as illustrated in FIG. 6, lists elements 402, 403, and 404 as the elements overlapping with the search target element 401, and since the sample text 1200 is the first sample text, all the elements 402, 403, and 404 are added as the conditions to indicate the candidates of the guideline element. Conditions 502, 503, and 504 to be added are illustrated as a condition 500 in FIG. 7.

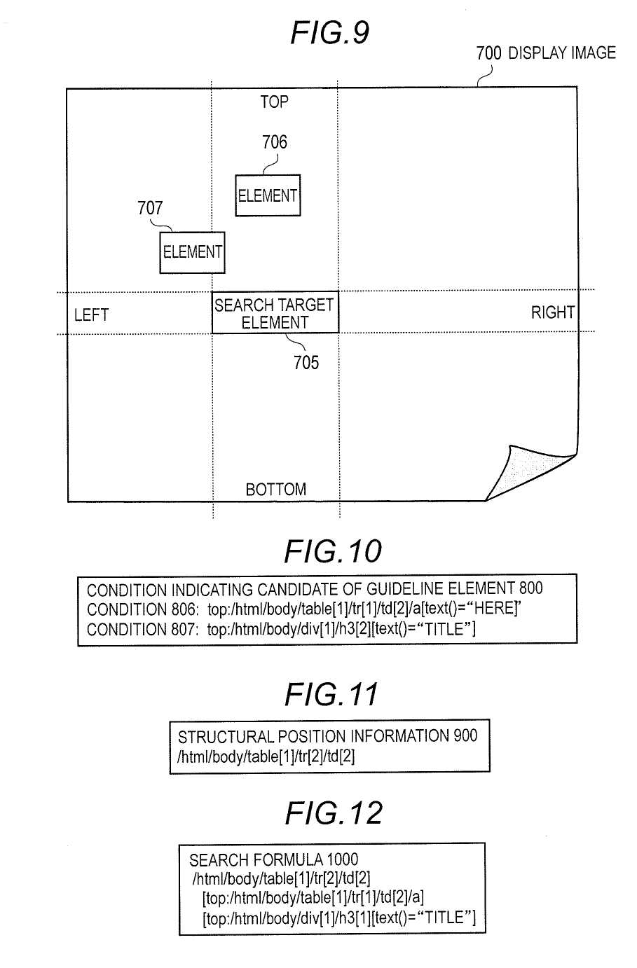

Next, the element specifying unit 112 displays the sample text 1300 as illustrated in FIG. 9 as a second sample text, specifies a search target element 705 by the instruction by the user, and delivers the same to the screen analyzing unit 113 and the structure analyzing unit 114.

The structure analyzing unit 114 generates structural position information 900 of the search target element 705 by the XPath formula as illustrated in FIG. 11. Meanwhile, in this example, since the structural position information 600 illustrated in FIG. 8 and the structural position information 900 illustrated in FIG. 11 match with each other, a special process is not required; however, when they do not match with each other, it is possible to configure to relax the condition such that they may be commonly specified. For example, it is possible to relax such that any of the steps of the search formula is made optional. Also, when the number of steps of the XPath formula is different, description of “descendant::” or “//” may be used to describe that the element of an optional number is present in the middle.

The screen analyzing unit 113 generates a display image 700 of the sample text 1300 as illustrated in FIG. 9 and lists elements 706 and 707 as the elements overlapping with the search target element 705.

The sample text 1300 is not the first sample text, so that the process is first performed for the element 706. Since none of the conditions 502, 503, and 504 illustrated in FIG. 7 searches for the element 706, a search formula condition 806 of the element 706 is generated as illustrated in FIG. 10. Out of the conditions 502, 503, and 504 illustrated in FIG. 7, the condition, which matches the best with the condition 806, is the condition 502, so that the condition 502 is relaxed and the condition of match of the character string is deleted. After confirming that the relaxed condition 502 specifies only one element for the sample texts 1200 and 1300, the condition 502 is rewritten.

Next, the process is similarly performed for a remaining element 707 and, since none of the conditions 502, 503, and 504 illustrated in FIG. 7 does not search for the element 707, a search formula condition 807 of the element 707 is generated as illustrated in FIG. 10. Out of the conditions 502, 503, and 504 illustrated in FIG. 7, the condition, which matches the best with the condition 807, is the condition 503, so that the condition 503 is relaxed. After confirming that the relaxed condition 503 specifies only one element for the sample texts 1200 and 1300, the condition 503 is rewritten.

Since the condition 504 is not used to search for any candidate, this is deleted.

As a result, the search formula 1000 illustrated in FIG. 12 is generated and this is accumulated in the search formula accumulating unit 122 with a name assigned thereto.

Meanwhile, the above-described condition is described by combining the sign (top, bottom, right, and left) indicating a direction of the relative position from the search target element and the XPath formula indicating the element of the condition and putting them into brackets “[” and “]” behind the element of a target for comparison as illustrated in FIGS. 7, 10, and 12. Meanwhile, although a method of describing the condition by the above-described method is herein described, it is possible to describe by another method if the two elements (the search target element and the guideline element) being the targets for comparison and directional relationship therebetween may be indicated.

Also, although the example of searching for the guideline element only for the search target element is described in this embodiment, it is also possible to configure, for the element indicating each step of the XPath formula generated by the structure analyzing unit, to list the element commonly present on the relative position thereto by the screen analyzing unit 113 and add the condition of the guideline element to each step by the search formula combining unit 115.

As described above, the structured document search formula generation system according to the above-described embodiment is provided with the element specifying unit 112, which specifies the search target element in the structured documents being a plurality of sample texts, which are the search targets, the sample text collecting unit 111, which obtains the sample texts from outside and accumulates them for each document type of the sample text, the sample text accumulating unit 121, which accumulates the sample texts collected by the sample text collecting unit 111 for each document type, the structure analyzing unit 114, which analyzes the structure of the structured document and generates the search formula indicating the common structural position of the search target elements in a plurality of structured documents, the screen analyzing unit 113, which analyzes the on-screen position information of the structured document and selects the element, which is the common guideline, in a plurality of structured documents of the search targets, and the search formula combining unit 115, which generates one obtained by adding the element, which is the common guideline, determined by the screen analyzing unit 113 as the condition to the search formula indicating the structural position generated by the structure analyzing unit 114.

By adopting such structure, the sample text collecting unit 111 collects a plurality of sample texts and accumulates them for each document type in the sample text accumulating unit 121, the element specifying unit 112 specifies the search target element in a plurality of sample texts accumulated in the sample text accumulating unit 121, and the structure analyzing unit 114 analyzes a plurality of structured documents, analyzes the structure of the sample text specified by the element specifying unit 112, and generates the search formula indicating the structural position common in a plurality of sample texts of the same type. Further, the search formula combining unit 115 adds the element present on the common relative position to the target element on the screen to the condition as the guideline element for a plurality of sample texts of the same type.

Next, an effect of this embodiment is described.

In this embodiment, it is configured to generate the search formula indicating the structural position, further analyze the display image for a plurality of sample texts, and add the element present on the common relative position to the target element on the screen to the condition as the guideline element, so that it is possible to provide the search formula generation system capable of specifying the structural position and in addition, automatically selecting the element, which should be the guideline, and describing the same in the search formula when the element acting as the guideline is not present on a structural related position but the element acting as the guideline is present on a display screen.

Meanwhile, it is possible to configure to improve a processing speed by determining an upper limit of the number of the guideline elements to be listed and listing only the elements closer to the search target element at the step S211.

Also, it is possible to configure such that, when a plurality of elements are selected at the step S219, the procedure returns to the step S217 to repeat the process for another condition, thereby trying to generate the condition by another combination.

### Second Embodiment

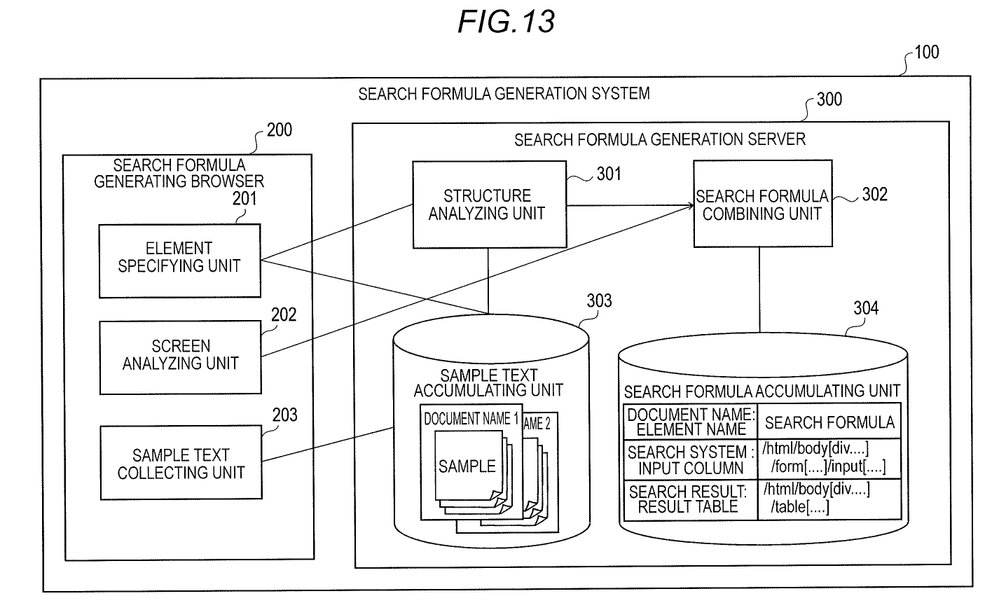

Next, a second embodiment of the present invention is described in detail with reference to FIG. 13.

FIG. 13 is a block diagram illustrating a configuration of the structured document search formula generation system (structured document search formula generating device) according to this embodiment. Unlike a stand-alone search formula generation system 10 in the first embodiment illustrated in FIG. 1, this embodiment adopts a networked search formula generation system 100.

With reference to FIG. 13, the search formula generation system 100 according to this embodiment is composed of a terminal device 200 and a server device 300 connected to each other via a network. Since the terminal device 200 is the terminal corresponding to a personal computer (PC) with a built-in browsing program (browser) having a network connection environment, this is hereinafter referred to as a search formula generating browser 200. Also, as the first embodiment illustrated in FIG. 1, for example, the server device 300 includes an arithmetic control unit 11, the storage device 12, the input/output device 13, and the communication device 14 as hardware and automatically generates the search formula, so that this is hereinafter referred to as a search formula generation server 300.

The search formula generating browser 200 includes an element specifying unit 201, a screen analyzing unit 202, and a sample text collecting unit 203 in addition to an HTML browsing function not illustrated.

The element specifying unit 201 has a function to obtain the sample text obtained from a sample text accumulating unit 303 of the search formula generation server 300, the identifier, which identifies the search target in the sample text, and the search target and deliver them to the screen analyzing unit 202 and a structure analyzing unit 301 of the search formula generation server 300.

The screen analyzing unit 202 has a function to analyze the display screen of the structured document, lists the element overlapping with the element specified by the element specifying unit 201, and deliver the same to a search formula combining unit 302 as the candidate of a position information condition.

The sample text collecting unit 203 has a function to obtain the structured document, which is the search target, from the externally connected server not illustrated and accumulate the same in the sample text accumulating unit 303 of the search formula generation server 300 with the document name assigned for each document type. Meanwhile, a preferred example of the structured document, which is the search target, is the HTML document.

The search formula generation server 300 includes the structure analyzing unit 301, the search formula combining unit 302, the sample text accumulating unit 303, and a search formula accumulating unit 304.

The structure analyzing unit 301 has a function to obtain the structured document from the sample text accumulating unit 303 by the sample text delivered from the element specifying unit 201 of the search formula generating browser 200, analyze the same, and generate the structural search formula of the search target element specified by the element specifying unit 201.

The search formula combining unit 302 has a function to analyze a candidate element received from the screen analyzing unit 202 of the search formula generating browser 200, determine the candidate, which should be added as the condition, combine the added search formula with the structural search formula received from the structure analyzing unit 301, and accumulate the same in the search formula accumulating unit 304. At that time, the search formula accumulating unit 304 accumulates the search formula combined by the search formula combining unit 302 together with the document name and an element name.

According to the structured document search formula generation system 100 configured as above, the sample text collecting unit 203 of the search formula generating browser 200 first obtains a plurality of sample texts being the HTML documents from the externally-connected server not illustrated and accumulates them in the sample text accumulating unit 303 of the search formula generation server 300 via the network. At that time, the sample text accumulating unit 303 accumulates the obtained HTML documents for each type under control by the sample text collecting unit 203.

Subsequently, the element specifying unit 201 of the search formula generating browser 200 specifies the search target element in each of a plurality of sample texts and delivers the same to the screen analyzing unit 202 and the structure analyzing unit 301 of the search formula generation server 300.

The screen analyzing unit 202, which receives the search target element, analyzes the display image of the structured document, lists the element overlapping with the search target element in an up-down direction or in a right-left direction, and delivers the same as the candidate of the position information condition to the search formula combining unit 302 of the search formula generation server 300.

On the other hand, the structure analyzing unit 301, which receives the search target element, generates the search formula indicating the structural position of the search target and delivers the same to the search formula combining unit 302.

The search formula combining unit 302, which receives the candidate of the position information condition and the search formula indicating the structural position, determines the candidate to be added as the condition following the flowchart in FIG. 3, combines the search formula obtained by adding the position information condition to the search formula indicating the structural position, and accumulates the same in the search formula accumulating unit 304.

In this embodiment, since it is configured to generate the search formula indicating the structural position, further analyze the display image for each of a plurality of sample texts, and add the element present on the common relative position to the target element on the screen to the condition as the guideline element, it is possible to provide the search formula generation system capable of specifying the structural position and in addition, automatically selecting the element, which should be the guideline, and describing the same in the search formula when the element acting as the guideline is not present on the structural related position but the element acting as the guideline is present on the display screen.

### Third Embodiment

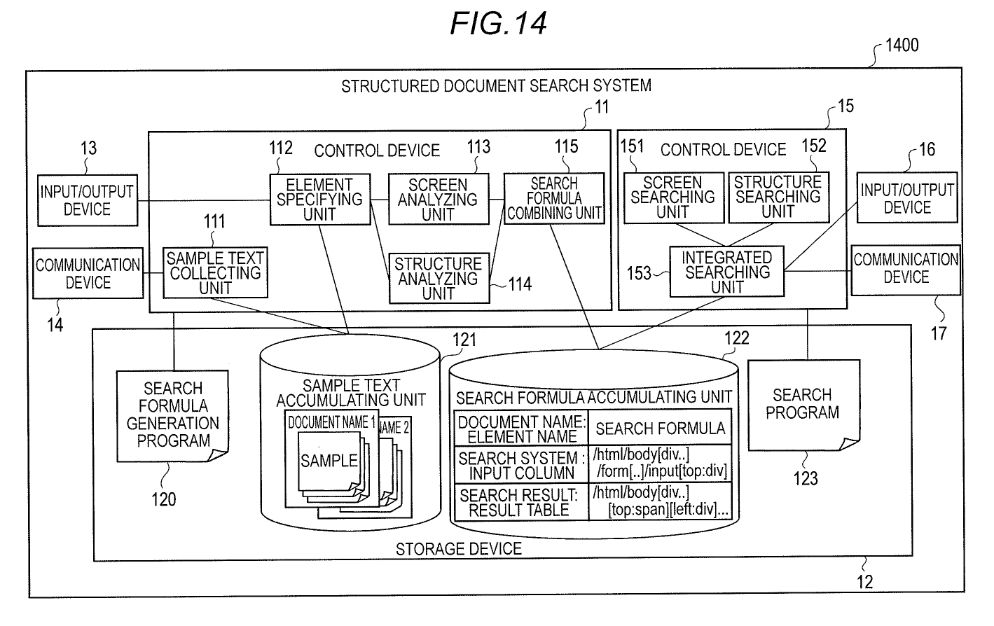

Next, a third embodiment of the present invention is described in detail with reference to FIG. 14.

FIG. 14 is a block diagram illustrating a configuration of a structured document search system 1400 according to this embodiment. Unlike the search formula generation system 10 in the first embodiment illustrated in FIG. 1, in this embodiment, in addition to the same configuration as the search formula generation system 10, a search program 123 is further included in the storage device 12, a control device 15, an input/output device 16, and a communication device 17 are included, and the control device 15 has a screen searching unit 151, a structure searching unit 152, and an integrated searching unit 153 by sequentially reading the search program 123.

The screen searching unit 151 has a function to create a display screen image by analyzing the structured document and confirm that the guideline element is present on a position specified by the condition of the search formula.

The structure searching unit 152 has a function to analyze the structured document and search the element according to the search formula indicating the structural position information.

The integrated searching unit 153 has a function to read the structured document, read the search formula from the search formula accumulating unit 122, extract the search formula indicating the structural position information from the search formula to deliver to the structure searching unit 152, extract the condition indicating the guideline element on the screen from the search formula to deliver to the screen searching unit 151, and output the search target element according to results of the structure searching unit 152 and the screen searching unit 151.

The structured document search system 1400 configured in this manner operates as follows.

That is to say, this operates as the search formula generating device 10 on a stage of generating the search formula, and further, on a stage of searching, the integrated searching unit 153 reads the structured document via the communication device 17, reads the search formula from the search formula accumulating unit 122, search the structural position information described in the search formula using the structure searching unit 152, confirms whether the condition indicating the on-screen position information described in the search formula is satisfied using the screen searching unit 151, and outputs the element through the input/output unit 16 as the search target element when the condition is satisfied.

In this embodiment, since it is configured to add the element present on the common position on the screen in each of a plurality of sample texts to the search formula as the condition in addition to the structural search formula and confirm that the element specified at the time of search is present, so that it is possible to provide the structured document search system, which surely searches the target element by specifying the structural position also when the guideline element is not structurally present.

Meanwhile, although the above-described structured document search formula generation system and structured document search system may be realized by the hardware, it is also possible to realize them by reading the program for allowing the computer to function as the system from a recording medium and executing the same by the computer.

Also, although the above-described structured document search formula generating method and structured document search method may be realized by the hardware, it is also possible to realize them by reading the program for allowing the computer to execute the methods from a computer-readable recording medium and the executing the same by the computer.

Also, the above-described hardware and software configurations are not especially limited, and any one may be applied when the function of the above-described components may be realized. For example, the one obtained by independently and separately configuring the parts (software modules) for each function of the above-described components or the one obtained by integrally configuring a plurality of functions by putting them in one part and the like may be applied.

Although a part or all of the above-described embodiments may be described as in following supplementary notes, this is not limited to the following.

{Supplementary Note 1}

A structured document search formula generating device, comprising: a sample text accumulating unit, which accumulates a plurality of sample texts each composed of a structured document being a search target for each document type; an element specifying unit, which specifies a search target element in each of the plurality of sample texts; a structure analyzing unit, which analyzes a structure of the sample text specified by the element specifying unit and executes a process to generate a search formula indicating a structural position of the specified search target element in a structure of the sample text; a screen analyzing unit, which analyzes a display image of the sample text specified by the element specifying unit and executes a process to determine an element present on a common relative position on the display image of each of the plurality of sample texts as a guideline element on a screen; and a search formula combining unit, which executes a process to generate one obtained by adding the guideline element on the screen determined by the screen analyzing unit as a condition to the search formula indicating the structural position generated by the structure analyzing unit.

{Supplementary Note 2}

The structured document search formula generating device according to the supplementary note 1, wherein the screen analyzing unit sequentially lists elements present on relative positions to the specified search target element as guideline element candidates in the plurality of sample texts, determines all the guideline element candidates as guideline elements on the screen for a first sample text and describes search formulae indicating the guideline elements as conditions, and, for second and subsequent sample texts, for each guideline element candidate, when the guideline element candidate is not selected by the already described conditions, relaxes the condition, which matches the best, out of the already described conditions so as to select the guideline element candidate, confirms whether only one element is searched for in each of the sample texts by the relaxed condition, and replaces the already described condition with the relaxed condition when only one element is searched for.

{Supplementary Note 3}

The structured document search formula generating device according to the supplementary note 2, wherein the screen analyzing unit lists the element overlapping with the search target element on the display image of the sample text in an up-down direction and in a right-left direction as the guideline element candidate.

{Supplementary Note 4}

The structured document search formula generating device according to the supplementary note 3, wherein the screen analyzing unit lists the elements of the number defined in advance from the element closer to the search target element on the display image of the sample text.

{Supplementary Note 5}

The structured document search formula generating device according to the supplementary note 1, wherein the structured document is described in HTML.

{Supplementary Note 6}

The structured document search formula generating device according to the supplementary note 1, wherein the search formula indicating the structural position is described by an XPath formula, and the guideline element on the screen is described by a sign indicating the relative position to the search target element on the display image of the sample text and the XPath formula indicating the structural position of the sample text.

{Supplementary Note 7}

The structured document search formula generating device according to the supplementary note 6, wherein the guideline element on the screen is described in a predicate of the XPath formula indicating the structural position.

{Supplementary Note 8}

A structured document search formula generating browser, comprising: an element specifying unit, which specifies a search target element in each of a plurality of sample texts each composed of a structured document being a search target; a sample text collecting unit, which collects the sample texts via a network to accumulate for each document type of the sample texts; and a screen analyzing unit, which analyzes the sample texts and lists an element present on a relative position to an element specified by the element specifying unit, wherein the structured document search formula generating browser transmits the sample texts, the specified element, and the listed element via the network.

{Supplementary Note 9}

A structured document search formula generation server, comprising: a sample text accumulating unit, which accumulates a plurality of sample texts each composed of a structured document being a search target; a structure analyzing unit, which analyzes a structure of each of the sample texts and generates a search formula indicating a structural position of an element specified in the sample text; and a search formula combining unit, which receives a search formula indicating the structural position of the specified element in the sample text, an element present on a relative position to the specified element, and adds the element present on a position common in a plurality of sample texts out of the received element to the search formula indicating the structural position, wherein the structured document search formula generation server receives the specified element and the element present on the relative position to the specified element via a network.

{Supplementary Note 10}

A structured document search device, comprising: a sample text accumulating unit, which accumulates a plurality of sample texts each composed of a structured document being a search target for each document type; an element specifying unit, which specifies a search target element in each of the plurality of sample texts; a structure analyzing unit, which analyzes a structure of the sample text specified by the element specifying unit and executes a process to generate a search formula indicating a structural position of the specified element; a screen analyzing unit, which analyzes a display image of the sample text specified by the element specifying unit and executes a process to determine the element present on a common relative position on the display image of each of the plurality of sample texts as a guideline element on a screen; a search formula combining unit, which executes a process to generate one obtained by adding the guideline element on the screen determined by the screen analyzing unit as a condition to the search formula indicating the structural position generated by the structure analyzing unit; a structure searching unit, which reads the structured document and the search formula indicating structural position information and searches for the search target element; a screen searching unit, which reads the structured document, the search target element, and the condition indicating the guideline element on the screen, creates a screen image of the structured document and confirms whether the condition indicating the guideline element on the screen meets; and an integrated searching unit, which reads the structured document and the search formula, extracts the search formula indicating the structural position out of the search formula to deliver to the structure searching unit, extracts the condition indicating the guideline element on the screen out of the search formula to deliver to the screen searching unit, and outputs the element in which all the conditions meet as the search target element.

{Supplementary Note 11}

A structured document search formula generating method, wherein a sample text accumulating unit accumulates a plurality of sample texts each composed of a structured document being a search target for each document type, an element specifying unit specifies a search target element in each of the plurality of sample texts, a structure analyzing unit analyzes a structure of the sample text specified by the element specifying unit and executes a process to generate a search formula indicating a structural position of the specified element in a structure of the sample text, a screen analyzing unit analyzes a display image of the sample text specified by the element specifying unit and executes a process to determine an element present on a common relative position on the display image of each of the plurality of sample texts as a guideline element on a screen, and a search formula combining unit generates one obtained by adding the guideline element on the screen determined by the screen analyzing unit as a condition to the search formula generated by the structure analyzing unit.

{Supplementary Note 12}

A structured document searching method, wherein a sample text accumulating unit accumulates a plurality of sample texts each composed of a structured document being a search target for each document type, an element specifying unit specifies a search target element in each of the plurality of sample texts, a structure analyzing unit analyzes a structure of the sample text specified by the element specifying unit and executes a process to generate a search formula indicating a structural position of the specified element, a screen analyzing unit analyzes a display image of the sample text specified by the element specifying unit and executes a process to determine an element present on a common relative position on the display image of each of the plurality of sample texts as a guideline element on a screen, a search formula combining unit executes a process to generate one obtained by adding the guideline element on the screen determined by the screen analyzing unit as a condition to the search formula indicating the structural position generated by the structure analyzing unit, a structure searching unit reads the structured document and the search formula indicating structural position information and searches for the search target element, a screen searching unit reads the structured document, the search target element, and the condition indicating the guideline element on the screen, creates a screen image of the structured document, and confirms whether the condition indicating the guideline element on the screen meets, and an integrated searching unit reads the structured document and the search formula, extracts the search formula indicating the structural position out of the search formula to deliver to the structure searching unit, extracts the condition indicating the guideline element on the screen out of the search formula to deliver to the screen searching unit, and outputs the element in which all the conditions meet as the search target element.

{Supplementary Note 13}

A structured document search formula generation program, for allowing a computer to function as: a sample text accumulating unit, which accumulates a plurality of sample texts each composed of a structured document being a search target for each document type; an element specifying unit, which specifies a search target element in each of the plurality of sample texts; a structure analyzing unit, which analyzes a structure of the sample text specified by the element specifying unit and executes a process to generate a search formula indicating a structural position of the specified search target element in a structure of the sample text, a screen analyzing unit, which analyzes a display image of the sample text specified by the element specifying unit and executes a process to determine an element present on a common relative position on the display image of each of the plurality of sample texts as a guideline element on a screen; and a search formula combining unit, which executes a process to generate one obtained by adding the guideline element on the screen determined by the screen analyzing unit as a condition to the search formula indicating the structural position generated by the structure analyzing unit.

{Supplementary Note 14}

A structured document search program for allowing a computer to function as: a sample text accumulating unit, which accumulates a plurality of sample texts each composed of a structured document being a search target for each document type; an element specifying unit, which specifies a search target element in each of the plurality of sample texts; a structure analyzing unit, which analyzes a structure of the sample text specified by the element specifying unit and executes a process to generate a search formula indicating a structural position of the specified element; a screen analyzing unit, which analyzes a display image of the sample text specified by the element specifying unit and executes a process to determine an element present on a common relative position on the display image of each of the plurality of sample texts as a guideline element on a screen; a search formula combining unit, which executes a process to generate one obtained by adding the guideline element on the screen determined by the screen analyzing unit as a condition to the search formula indicating the structural position generated by the structure analyzing unit; a structure searching unit, which reads the structured document and the search formula indicating structural position information and searches for the search target element; a screen searching unit, which reads the structured document, the search target element, and the condition indicating the guideline element on the screen, creates a screen image of the structured document, and confirms whether the condition indicating the guideline element on the screen meets; and an integrated searching unit, which reads the structured document and the search formula, extracts the search formula indicating the structural position out of the search formula to deliver to the structure searching unit, extracts the condition indicating the guideline element on the screen out of the search formula to deliver to the screen searching unit, and outputs the element in which all the conditions meet as the search target element.

Although the invention according to the present application is described above by referring to the embodiments, the invention according to the present application is not limited to the above-described embodiments. Various modifications, which one skilled may understand, may be made to the configuration and the detail of the invention according to the present application without departing from the scope of the invention according to the present application.

This application claims priority based on the Japanese Patent Application No. 2009-195449 filed on Aug. 26, 2009 and the entire disclosure thereof is herein incorporated by reference.

### INDUSTRIAL APPLICABILITY

The present invention may be applied to application such as a Web page test tool, which automatically operates a Web page. Also, the present invention may be applied to the application to extract information from the Web page.

### REFERENCE SIGNS LIST

10, 100 search formula generation system
11 control device
12 storage device
13 input/output device
14 communication device
111 sample text collecting unit
112 element specifying unit
113 screen analyzing unit
114 structure analyzing unit
115 search formula combining unit
120 search formula generation program
121 sample text accumulating unit
122 search formula accumulating unit
123 search program
151 screen searching unit
152 structure searching unit
153 integrated searching unit
200 search formula generating browser
300 search formula generation server
400, 700 display image
401, 705 search target element
402, 403, 404, 706, 707 element
500, 800 condition indicating candidate of guideline element
600, 900 structural position information
1000 search formula
1200, 1300 sample text
1400 structured document search system

1. A structured document search formula generating device, comprising:
a sample text accumulating unit, which accumulates a plurality of sample texts each composed of a structured document being a search target for each document type;
an element specifying unit, which specifies a search target element in each of the plurality of sample texts;
a structure analyzing unit, which analyzes a structure of the sample text specified by the element specifying unit and executes a process to generate a search formula indicating a structural position of the specified search target element in a structure of the sample text;
a screen analyzing unit, which analyzes a display image of the sample text specified by the element specifying unit and executes a process to determine an element present on a common relative position on the display image of each of the plurality of sample texts as a guideline element on a screen; and
a search formula combining unit, which executes a process to generate one obtained by adding the guideline element on the screen determined by the screen analyzing unit as a condition to the search formula indicating the structural position generated by the structure analyzing unit.

2. The structured document search formula generating device according to claim 1, wherein
the screen analyzing unit sequentially lists elements present on relative positions to the specified search target element as guideline element candidates in the plurality of sample texts, determines all the guideline element candidates as guideline elements on the screen for a first sample text and describes search formulae indicating the guideline elements as conditions, and, for second and subsequent sample texts, for each guideline element candidate, when the guideline element candidate is not selected by the already described conditions, relaxes the condition, which matches the best, out of the already described conditions so as to select the guideline element candidate, confirms whether only one element is searched for in each of the sample texts by the relaxed condition, and replaces the already described condition with the relaxed condition when only one element is searched for.

3. The structured document search formula generating device according to claim 2, wherein
the screen analyzing unit lists the element overlapping with the search target element on the display image of the sample text in an up-down direction and in a right-left direction as the guideline element candidate.

4. The structured document search formula generating device according to claim 3, wherein
the screen analyzing unit lists the elements of the number defined in advance from the element closer to the search target element on the display image of the sample text.

5. The structured document search formula generating device according to claim 1, wherein
the structured document is described in HTML.

6. The structured document search formula generating device according to claim 1, wherein
the search formula indicating the structural position is described by an XPath formula, and
the guideline element on the screen is described by a sign indicating the relative position to the search target element on the display image of the sample text and the XPath formula indicating the structural position of the sample text.

7. The structured document search formula generating device according to claim 6, wherein
the guideline element on the screen is described in a predicate of the XPath formula indicating the structural position.

8. A structured document search formula generating browser, comprising:
an element specifying unit, which specifies a search target element in each of a plurality of sample texts each composed of a structured document being a search target;
a sample text collecting unit, which collects the sample texts via a network to accumulate for each document type of the sample texts; and
a screen analyzing unit, which analyzes the sample texts and lists an element present on a relative position to an element specified by the element specifying unit,
wherein the structured document search formula generating browser transmits the sample texts, the specified element, and the listed element via the network.

9. A structured document search formula generation server, comprising:
a sample text accumulating unit, which accumulates a plurality of sample texts each composed of a structured document being a search target;
a structure analyzing unit, which analyzes a structure of each of the sample texts and generates a search formula indicating a structural position of an element specified in the sample text; and
a search formula combining unit, which receives a search formula indicating the structural position of the specified element in the sample text, and an element present on a relative position to the specified element, and adds the element present on a position common in a plurality of sample texts out of the received element to the search formula indicating the structural position,
wherein the structured document search formula generation server receives the specified element and the element present on the relative position to the specified element via a network.

10. A structured document search device, comprising:
a sample text accumulating unit, which accumulates a plurality of sample texts each composed of a structured document being a search target for each document type;
an element specifying unit, which specifies a search target element in each of the plurality of sample texts;
a structure analyzing unit, which analyzes a structure of the sample text specified by the element specifying unit and executes a process to generate a search formula indicating a structural position of the specified element;
a screen analyzing unit, which analyzes a display image of the sample text specified by the element specifying unit and executes a process to determine the element present on a common relative position on the display image of each of the plurality of sample texts as a guideline element on a screen;
a search formula combining unit, which executes a process to generate one obtained by adding the guideline element on the screen determined by the screen analyzing unit as a condition to the search formula indicating the structural position generated by the structure analyzing unit;
a structure searching unit, which reads the structured document and the search formula indicating structural position information and searches for the search target element;
a screen searching unit, which reads the structured document, the search target element, and the condition indicating the guideline element on the screen, creates a screen image of the structured document and confirms whether the condition indicating the guideline element on the screen meets; and
an integrated searching unit, which reads the structured document and the search formula, extracts the search formula indicating the structural position out of the search formula to deliver to the structure searching unit, extracts the condition indicating the guideline element on the screen out of the search formula to deliver to the screen searching unit, and outputs the element in which all the conditions meet as the search target element.

11. A structured document search formula generating method, wherein
a sample text accumulating unit accumulates a plurality of sample texts each composed of a structured document being a search target for each document type,
an element specifying unit specifies a search target element in each of the plurality of sample texts,
a structure analyzing unit analyzes a structure of the sample text specified by the element specifying unit and executes a process to generate a search formula indicating a structural position of the specified element in a structure of the sample text,
a screen analyzing unit analyzes a display image of the sample text specified by the element specifying unit and executes a process to determine an element present on a common relative position on the display image of each of the plurality of sample texts as a guideline element on a screen, and
a search formula combining unit generates one obtained by adding the guideline element on the screen determined by the screen analyzing unit as a condition to the search formula generated by the structure analyzing unit.

12. A structured document searching method, wherein
a sample text accumulating unit accumulates a plurality of sample texts each composed of a structured document being a search target for each document type,
an element specifying unit specifies a search target element in each of the plurality of sample texts,
a structure analyzing unit analyzes a structure of the sample text specified by the element specifying unit and executes a process to generate a search formula indicating a structural position of the specified element,
a screen analyzing unit analyzes a display image of the sample text specified by the element specifying unit and executes a process to determine an element present on a common relative position on the display image of each of the plurality of sample texts as a guideline element on a screen,
a search formula combining unit executes a process to generate one obtained by adding the guideline element on the screen determined by the screen analyzing unit as a condition to the search formula indicating the structural position generated by the structure analyzing unit,
a structure searching unit reads the structured document and the search formula indicating structural position information and searches for the search target element,
a screen searching unit reads the structured document, the search target element, and the condition indicating the guideline element on the screen, creates a screen image of the structured document, and confirms whether the condition indicating the guideline element on the screen meets, and
an integrated searching unit reads the structured document and the search formula, extracts the search formula indicating the structural position out of the search formula to deliver to the structure searching unit, extracts the condition indicating the guideline element on the screen out of the search formula to deliver to the screen searching unit, and outputs the element in which all the conditions meet as the search target element.

13. A structured document search formula generation program, for allowing a computer to function as:
a sample text accumulating unit, which accumulates a plurality of sample texts each composed of a structured document being a search target for each document type;
an element specifying unit, which specifies a search target element in each of the plurality of sample texts;
a structure analyzing unit, which analyzes a structure of the sample text specified by the element specifying unit and executes a process to generate a search formula indicating a structural position of the specified search target element in a structure of the sample text,
a screen analyzing unit, which analyzes a display image of the sample text specified by the element specifying unit and executes a process to determine an element present on a common relative position on the display image of each of the plurality of sample texts as a guideline element on a screen; and
a search formula combining unit, which executes a process to generate one obtained by adding the guideline element on the screen determined by the screen analyzing unit as a condition to the search formula indicating the structural position generated by the structure analyzing unit.

14. A structured document search program for allowing a computer to function as:
a sample text accumulating unit, which accumulates a plurality of sample texts each composed of a structured document being a search target for each document type;
an element specifying unit, which specifies a search target element in each of the plurality of sample texts;
a structure analyzing unit, which analyzes a structure of the sample text specified by the element specifying unit and executes a process to generate a search formula indicating a structural position of the specified element;
a screen analyzing unit, which analyzes a display image of the sample text specified by the element specifying unit and executes a process to determine an element present on a common relative position on the display image of each of the plurality of sample texts as a guideline element on a screen;
a search formula combining unit, which executes a process to generate one obtained by adding the guideline element on the screen determined by the screen analyzing unit as a condition to the search formula indicating the structural position generated by the structure analyzing unit;
a structure searching unit, which reads the structured document and the search formula indicating structural position information and searches for the search target element;
a screen searching unit, which reads the structured document, the search target element, and the condition indicating the guideline element on the screen, creates a screen image of the structured document, and confirms whether the condition indicating the guideline element on the screen meets; and
an integrated searching unit, which reads the structured document and the search formula, extracts the search formula indicating the structural position out of the search formula to deliver to the structure searching unit, extracts the condition indicating the guideline element on the screen out of the search formula to deliver to the screen searching unit, and outputs the element in which all the conditions meet as the search target element.
